(19) United States
(12) Patent Application Publication
(10) Pub. No.: US 2021/0323640 A1
(43) Pub. Date: Oct. 21, 2021

(54) Rotary Cam Operated Release Mechanism

(71) Applicant: InterOcean Systems, LLC, Broussard, LA (US)

(72) Inventor: Peter James DOREY, Vista, CA (US)

(21) Appl. No.: 17/270,838

(22) PCT Filed: Aug. 22, 2019
(86) PCT No.: PCT/US2019/047701

§ 371 Date: Feb. 23, 2021

Related U.S. Application Data
(60) Provisional application No. 62/722,577, filed on Aug. 24, 2018.

(51) Int. Cl. B63B 21/50

(52) U.S. Cl. CPC B63B 21/502; B63B 2021/505

(57) ABSTRACT

A release mechanism for a tether assembly. A circular base ring has a central opening sized to accept a connecting member, and a plurality of radial slots. Dogs are disposed in the radial slots, and movable radially inwardly and outwardly. A cam ring having angled slots is operatively connected to the base ring, with upturned ends on the dogs engaged in the angled slots. Relative rotation between the cam ring and the base ring, by hydraulic cylinders connecting the two rings, moves the dogs radially inwardly and outwardly. In their radially inward position the dogs engage a circumferential groove in an elongated connecting member, thereby connecting the tether assembly.

### CROSS REFERENCE TO RELATED APPLICATIONS

This patent application claims priority to U.S. provisional patent application Ser. No. 62/722,577, filed Aug. 24, 2018, for all purposes. This application incorporates the disclosure of that provisional application by reference, to the extent not inconsistent with this application.

### BACKGROUND

### Field of the Invention

This invention relates to remotely operable release mechanisms, to enable releasing or disconnection of sections of various types of mechanical members.

### SUMMARY OF THE INVENTION

Disclosed is a release mechanism for placement in a floating vessel or structure mooring tether assembly or similar connecting member, which moors or connects the floating structure to some structure on or near the seafloor. The release mechanism permits the sections of the tether assembly to be disconnected, thereby disconnecting the structure from the subsurface mooring point.

More broadly, the release mechanism permits separating a tether assembly or other connecting member, which is connecting a vessel or structure to a mooring point, in any setting and for any purpose.

### BRIEF DESCRIPTION OF THE DRAWINGS

FIG. 1 is a general exemplary setting showing placement of the release mechanism in a tether assembly in an offshore system. For a variety of reasons, it may be desired or necessary that the tether assembly be separated. While FIG. 1 shows the release mechanism positioned above the surface of the water, it is understood that the release mechanism may be positioned below the surface of the water, as well.

FIGS. 2-10 show detail of a first embodiment of the release mechanism. Broadly, release mechanism 10 comprises a locking mechanism 20 which connects to a connecting member 100, which may be referred to as a stinger, when the mechanism is latched. It is understood that in one presently preferred embodiment, locking mechanism 20 is connected to the structure; a temporary line or tether runs from a winch positioned above release mechanism 20, the temporary line or tether connecting to the connecting member or stinger. The temporary line tether can be removed prior to releasing the connecting member or stinger. Release mechanism 20 is therefore stationary (fixed to the structure), and the line or tethers and stinger pass through rope guides in the center of release mechanism 20. Disconnecting locking mechanism 20 from connecting member 100 releases the tether assembly.

FIG. 2 is an exploded view of locking mechanism 20.

FIG. 3 shows connecting member 100 positioned below locking mechanism 20. It can be seen that connecting member 100 comprises a circumferential groove 102 on an outside surface, into which a plurality of dogs 40 (later described) latch in order to lock locking mechanism 20 to connecting member 100.

FIG. 4 is a perspective view of locking mechanism 20 with connecting member 100 positioned therein.

FIG. 5 is a cross section view of locking mechanism 20 with connecting member 100 as in FIG. 4, with the dogs retracted.

FIGS. 6A and 6B are cross section views of locking mechanism 20 with connecting member 100 as in FIGS. 4 and 5, with locking dogs 40 retracted.

FIGS. 7A and 7B are cross section views of locking mechanism 20 with connecting member 100 as in FIGS. 4 and 5, with cam ring 28 partially rotated and locking dogs 40 partially advanced.

FIGS. 8A and 8B are cross section views of locking mechanism 20 with connecting member 100 as in FIGS. 4 and 5, with locking dogs 40 fully advanced and the apparatus locked.

FIGS. 9 and 10 are more detailed cross section views showing locking dogs 40 advanced (FIG. 9) and retracted (FIG. 10).

FIGS. 11-15 illustrate a second embodiment of locking mechanism 20.

FIG. 11 is a perspective, cross section view of locking mechanism 20 with a connecting member 100 positioned therein.

FIG. 12 is a top view of locking mechanism 20, in a locked position.

FIG. 13 is a top view of locking mechanism 20, in an unlocked position.

FIG. 14 is a perspective cross section view of locking mechanism 20, in a locked position.

FIG. 15 is a perspective cross section view of locking mechanism 20, in an unlocked position.

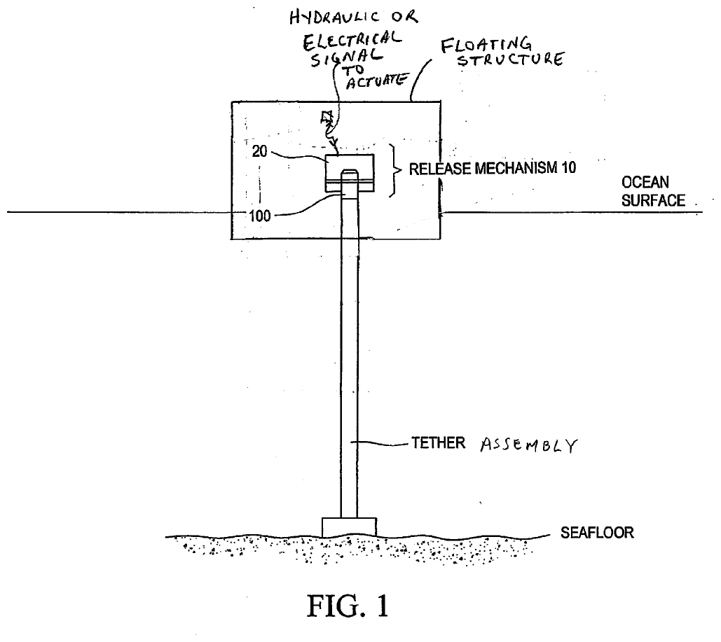

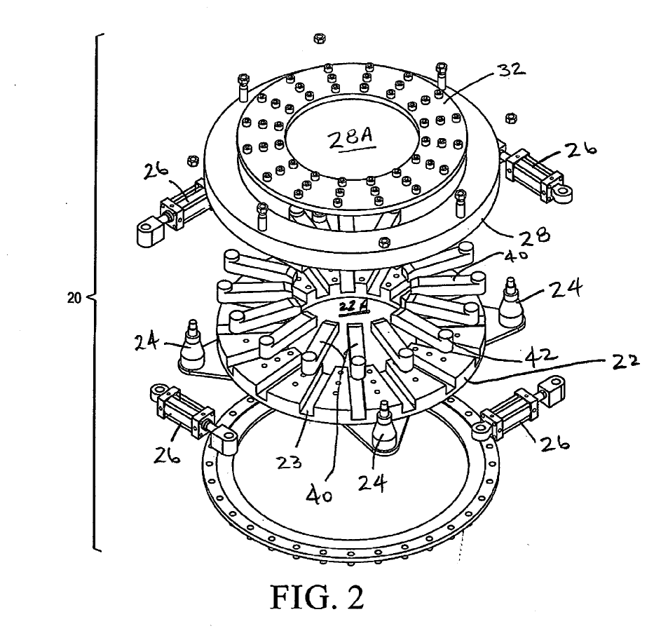

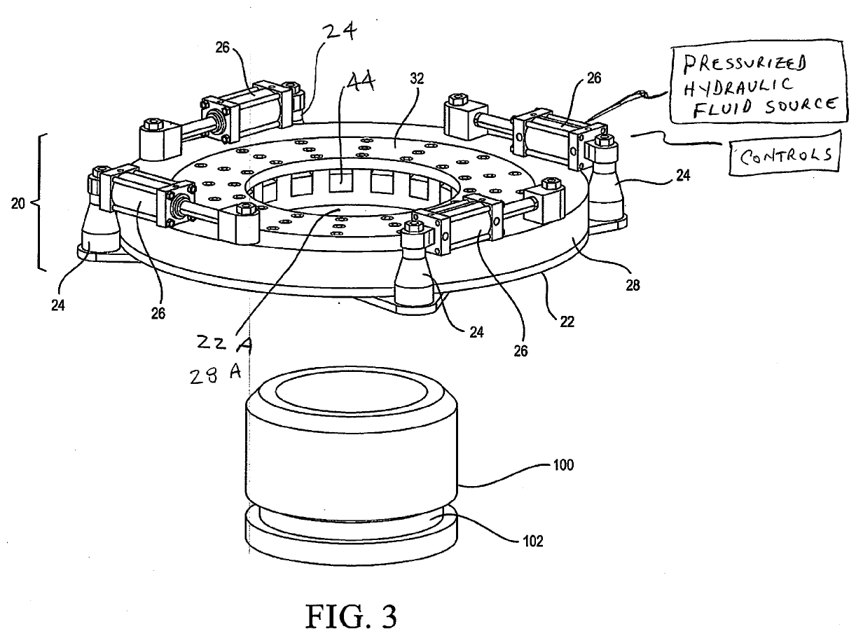

### DESCRIPTION OF THE PRESENTLY PREFERRED EMBODIMENTS

### A First Embodiment

As will be described in more detail below and in connection with the drawings, locking mechanism 20 comprises a generally circular base ring 22 and a generally circular cam ring 28. A means for creating relative rotation between base ring 22 and cam ring 28 is provided, which in a presently preferred embodiment comprises a plurality of hydraulic cylinders, described in more detail below. In a presently preferred embodiment, locking mechanism 20 comprises mounts 24 on which hydraulic cylinders 26 are mounted (that is, one end of hydraulic cylinders 26 are connected to mounts 24). Base ring 22 comprises a central opening 22A sized to accommodate a connecting member 100. The other ends of hydraulic cylinders 26 are connected via secondary mounts or clevises to a circular cam ring 28, which is positioned proximal to, typically resting atop base ring 22 and is rotatably movable on and rotatably connected to base ring 22. As can be seen, cam ring 28 comprises a plurality of angled cam grooves or slots 30, and also comprises a central opening 28A sized to accommodate a connecting member 100. A plurality of dogs 40 are positioned in channels 23 on base ring 22, generally in a position radiating outwardly, as can be seen in the figures. Base ring 22 (which may comprise multiple sections or parts) preferably comprises a plurality of channels 23 within which dogs 40 move radially. Each dog 40 has an upwardly raised portion, typically proximal a radially outward end 42, each of the raised portions engaging an angled slot 30 in cam ring 28. A cap ring 32 connected to base ring 22 holds dogs 40 in place in channels 23, while permitting them to move radially inwardly and outwardly. The end of each dog 40 opposite radially outward end 42, namely radially inward end 44, is shaped so as to engage groove 102 in connecting member 100.

A pressurized hydraulic fluid source is connected to hydraulic cylinders 26. Controls are provided as required to control hydraulic fluid flow to the hydraulic cylinders 26.

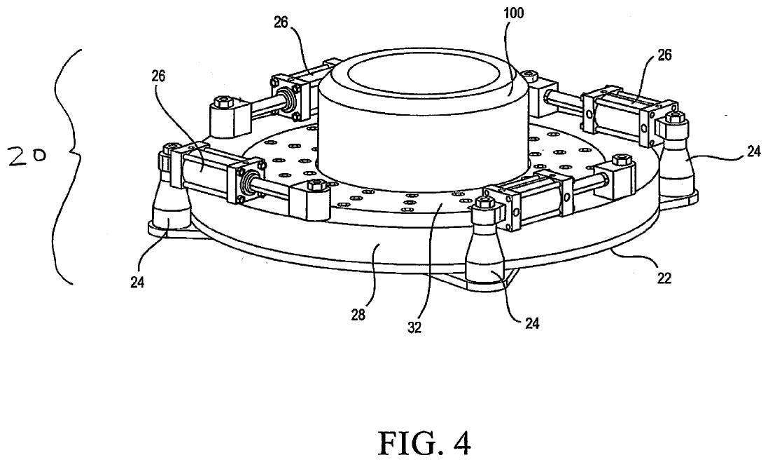

FIG. 4 shows connecting member 100 fully inserted into locking mechanism 20.

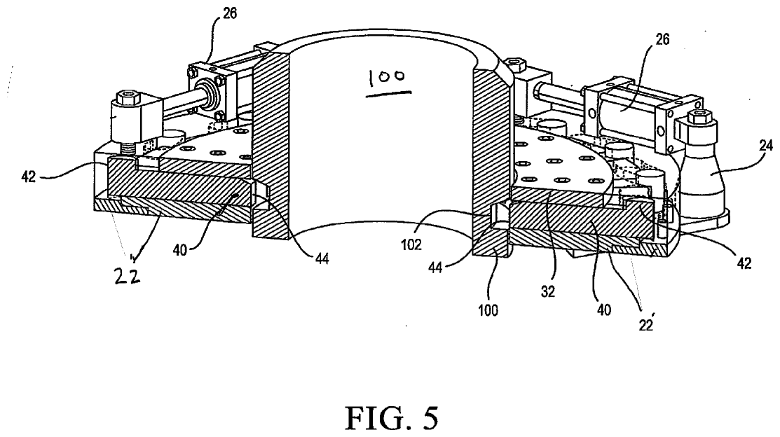

FIG. 5 is a cross section view of the arrangement of FIG. 4, with dogs 40 retracted (i.e. not engaged with groove 102).

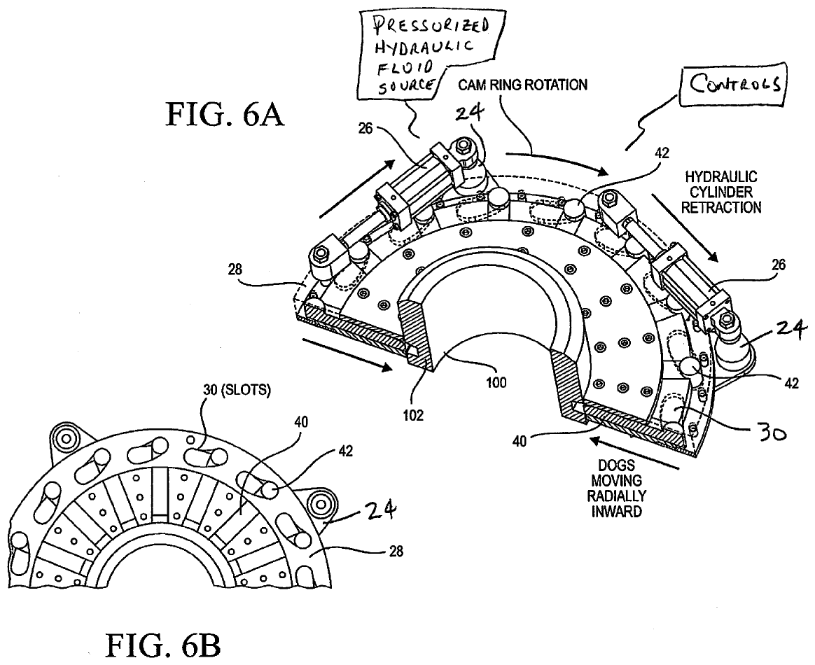

FIG. 6 comprises two views in greater detail of release mechanism 10. In FIG. 6A, hydraulic cylinders 26 are starting to retract, in the direction of the arrows as shown. This retraction in turn rotates cam ring 28 in that same direction. As cam ring 28 moves, dogs 40 are forced radially inward, by virtue of raised, radially outward ends 42 engaged in cam slots 30. This movement can be understood from the drawings, as movement of cam ring 28/cam slots 30 in the described direction forces radially outward ends 42 along the cam surface, hence radially inward. FIG. 6B additionally shows detail of the cam ring/cam slot/dog positioning.

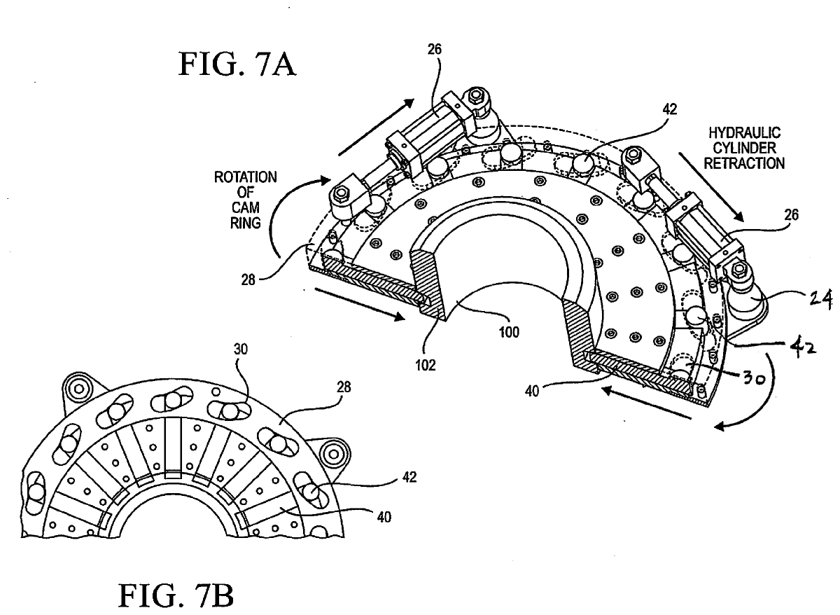

FIG. 7 is a view as hydraulic cylinders 26 continue to retract and to rotate cam ring 28, hence continue to force dogs 40 radially inward. FIG. 7A shows further rotation of cam ring 28, and further radially inward movement of dogs 40. FIG. 7B additionally shows further detail of the cam ring/cam slot/dog positioning.

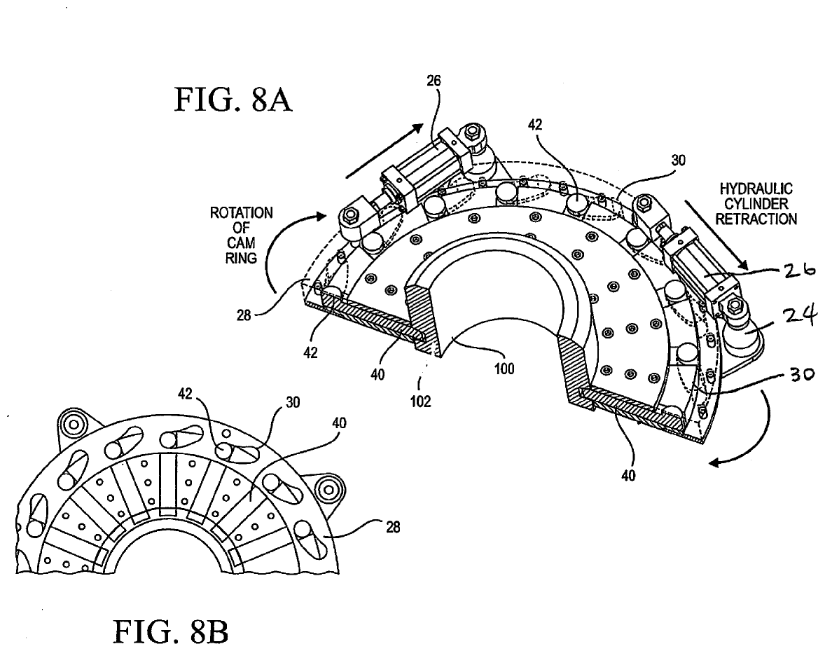

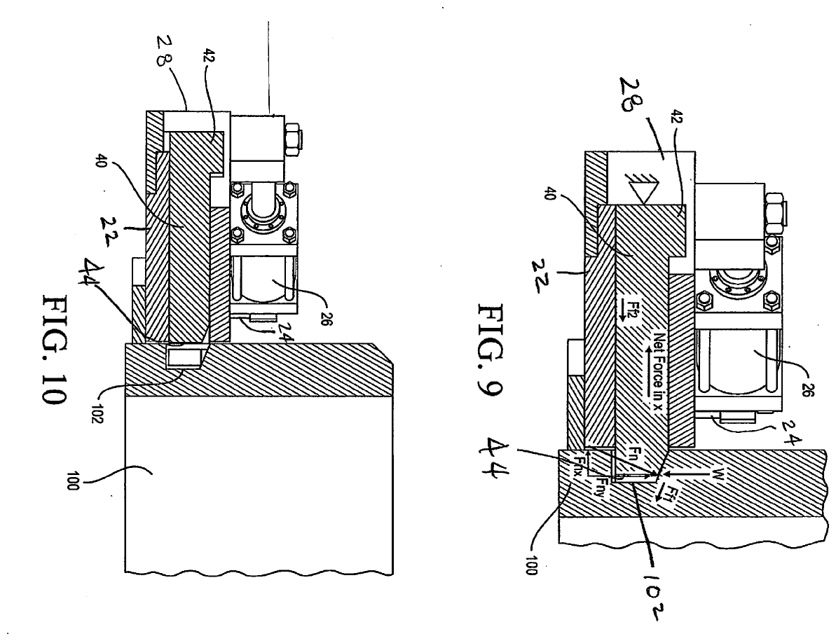

FIG. 8 is yet another view of the progression of rotation of cam ring 28, with hydraulic cylinders 26 fully retracted, and cam ring 28 fully rotated and dogs 40 in their final “locked in” position. As can be seen in FIG. 8A, dogs 40 are fully engaged in circumferential groove 102. As can be further seen, particularly in FIG. 8B, the shape of cam slots 30 are shaped so as to lock dogs 40 in their radially inwardly position, when cam ring 28 is fully rotated; namely, cam slots 30 comprise a section at their radially innermost end, in which the slot is not angled but instead is directed more nearly along or substantially along a circumferential line; this effectively forms a lock to hold dogs 40 in their radially inwardly and engaged position.

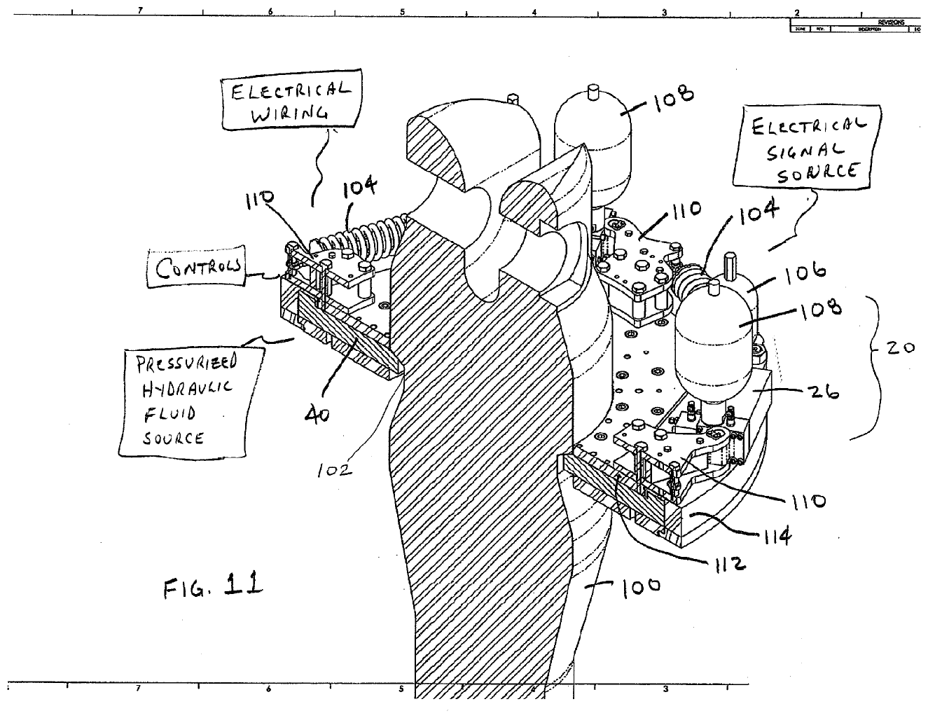

FIGS. 9 and 10 are cross section views showing dogs 40 engaged and disengaged, respectively, with groove 102.

It is to be understood that the particular movement of hydraulic cylinders 26 is by way of example only; the extension and retraction of hydraulic cylinders 26 could be reversed, i.e. hydraulic cylinders 26 could be extended rather than retracted to lock the mechanism.

It is to be understood that the means for creating relative rotation between base ring 22 and cam ring 28 could be another mechanism than the hydraulic cylinders above described, such as electric motors, a lead screw arrangement, gearing or other means known in the relevant art.

### A Second Embodiment

FIGS. 11 to 15 show a second embodiment of release mechanism 10, and more particularly locking mechanism 20. Where applicable, common element numbers (as those in connection with the first embodiment) are used for these drawings.

In this embodiment, similar to the first embodiment described above, a means for creating relative rotation between the base ring and the cam ring is provided, which in a preferred embodiment comprises a plurality of hydraulic cylinders. In this embodiment, one end of hydraulic cylinders 26 are mounted to brackets 110, which in turn are mounted to a non-rotating, stationary base ring 112. The other end of hydraulic cylinders 26 are mounted to a rotating cam ring 114. Rotating cam ring 114 comprises slots 30 as in the first embodiment described above, see for example FIGS. 6B, 7B, and 8B. Hydraulic accumulators 108 (high) and 106 (low) store pressurized hydraulic fluid for actuation of hydraulic cylinders 26, in response to (in a presently preferred embodiment) an electrical signal transmitted via hard-wiring from the ship or other structure being moored or connected. It is to be understood that in other embodiments and for other applications, an acoustic device/trigger could be used to actuate the locking mechanism. Electrical wiring and controls as required are provided, as depicted in schematical form.

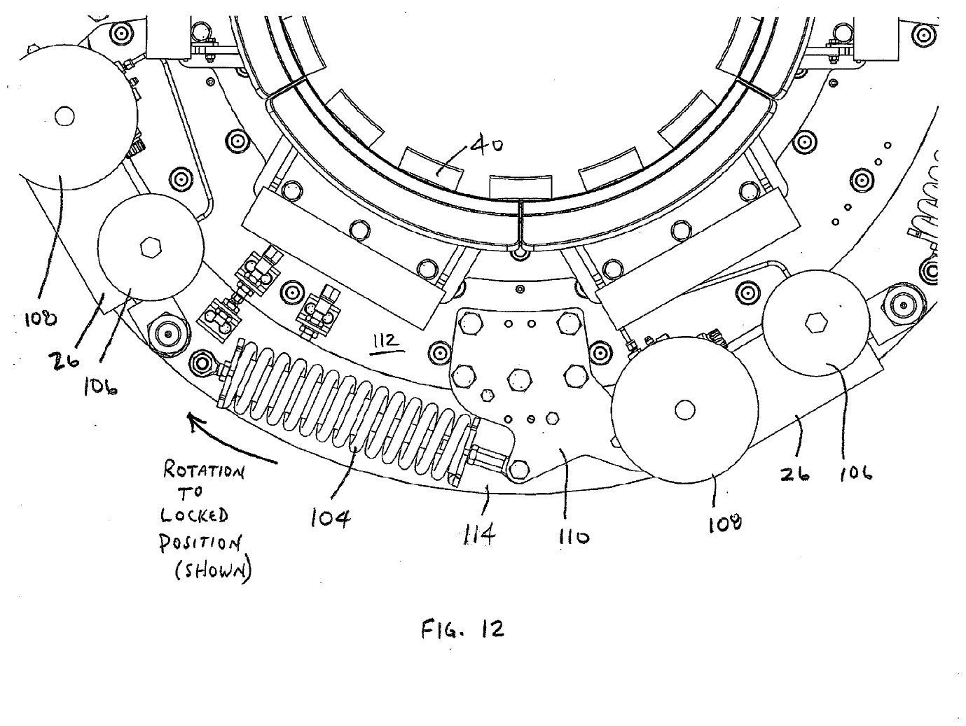

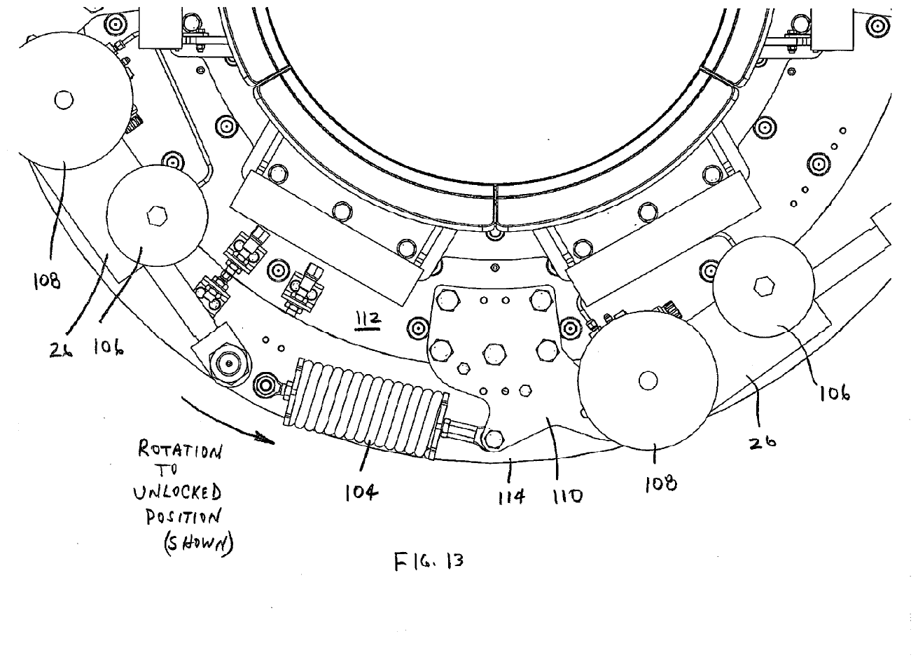

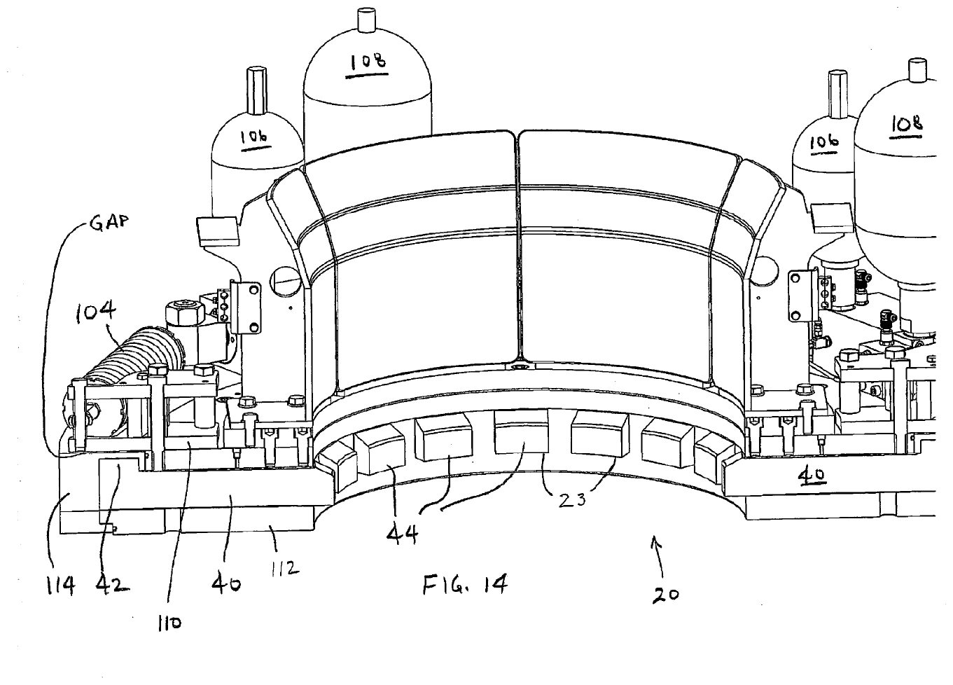

Springs 104, which in a presently preferred embodiment comprise coil springs, are disposed between base ring 112 and cam ring 114, for example connected at one end to stationary base ring 112 and at the other end to rotating cam ring 114. Preferably, springs 104 are mounted so as to create the locked position as the “fail safe” position. In a presently preferred embodiment, springs 104 are normally in compression, tending to rotate rotating cam ring 114 toward a locked position; said another way, springs 104 bias cam ring toward a position in which dogs 40 are in their radially inward position and the mechanism locked. In FIG. 12, the apparatus is shown in a locked position, with the rotating cam ring 114 fully rotated relative to stationary base ring 112. In this position, springs 104 are fully extended, as shown, and hydraulic cylinders 26 are fully retracted. In FIG. 13, the apparatus is shown in an unlocked position, with the rotating cam ring 114 fully rotated to a second, unlocked position, relative to stationary base ring 112. In this position, springs 104 are fully retracted, as shown, and hydraulic cylinders 26 are fully extended.

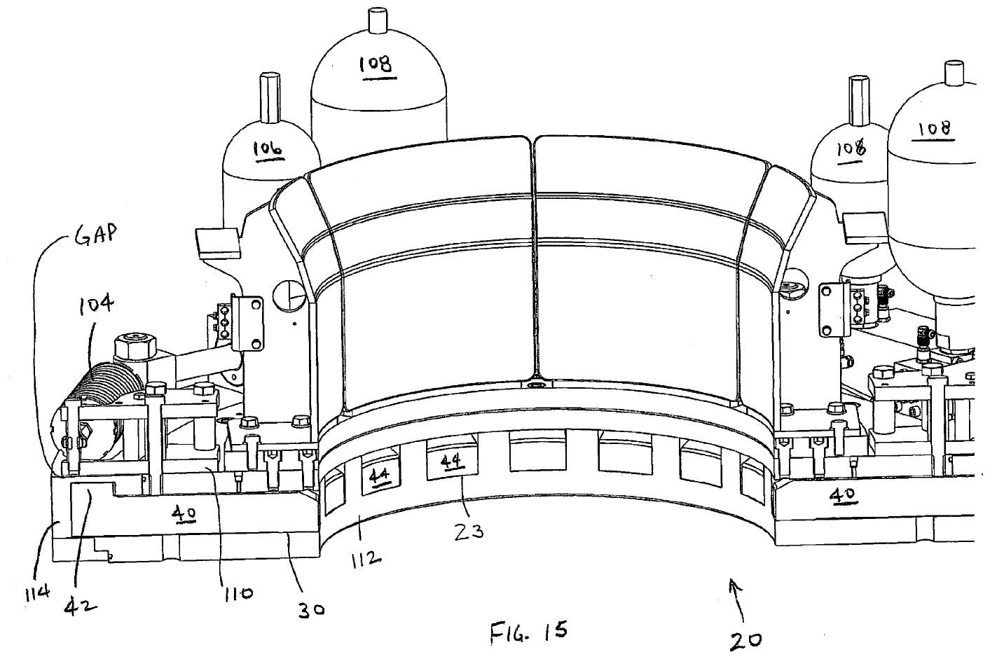

FIG. 14 is a perspective, cross section view of locking mechanism 20, in its locked position, as in FIG. 12. Dogs 40 are in their fully radially inward position. FIG. 15 is a perspective, cross section view of locking mechanism 20, in its unlocked position, as in FIG. 13. Dogs 40 are in their fully radially outward position. As can be seen in FIGS. 14 and 15, a gap between brackets 110 and cam ring 114 permits easy rotation of cam ring 114.

It is to be understood that the means for creating relative rotation between base ring 112 and cam ring 114 could be another mechanism than the hydraulic cylinders above described, such as electric motors, a lead screw arrangement, gearing or other means known in the relevant art.

### Operation of the Locking Mechanism, Materials, Fabrication

As previously noted, release mechanism 10, and more particularly locking mechanism 20, may be positioned either above or below the water surface, when used in a marine environment; however, it is understood that locking mechanism 20 may be used in land-based settings, as well.

Locking mechanism 20 must be unlocked or opened, with dogs 40 retracted (either hydraulically or manually) in order for connecting member 100 to be fully positioned therein. Once so positioned, hydraulic pressure on hydraulic cylinders 26 can be relieved, and (in the second embodiment above described) cam ring 114 will be rotated under spring bias from springs 104, and dogs 40 will move radially inwardly under the force from cam ring 114, latching into circumferential groove 102 or similar profile in connecting member 100. This makes locking mechanism “fail safe,” in that if hydraulic pressure is lost the mechanism remains locked.

It is understood that in addition to the forces placed on dogs 40 by springs 104 (acting through cam ring 28 or 114), forces from hydraulic cylinders 26 (again, acting on cam ring 28 or 114) can be used to move dogs 40 into place. Preferably, proximity switches positioned on locking mechanism 20 indicate when the mechanism is fully locked.

Locking mechanism 20 may be released under load conditions by high-flow poppet valves; or in a controlled manner by a secondary solenoid actuated valve under operator control. In addition, locking mechanism 20 may be locked/unlocked in a controlled manner, using a hydraulic hand pump or a manually operated jacking screw.

Preferably, a hydraulic system with a high degree of redundancy is used, for example four redundant hydraulic systems. High pressure hydraulic accumulators 108 will store sufficient hydraulic energy to operate locking mechanism 20 in the absence of external pressure, and will provide high hydraulic fluid flow rates to operate locking mechanism 20 quickly. Low pressure hydraulic accumulators 106 are installed on each hydraulic cylinder 26, to capture displaced hydraulic fluid from piston movement. A hydraulic system is provided to replenish the accumulators after a release, and if needed to manually operate the hydraulic cylinders to lock or unlock.

Release mechanism 10, in particular locking mechanism 20, may be fabricated from materials known in the relevant art, including high strength metals, alloys, etc.; where applicable, non-metallic elements may be used. The moving contacting surfaces of locking mechanism 20 may be made of suitable materials and/or clad or coated with suitable materials to provide required bearing strength, corrosion resistance and galling resistance. It is to be understood that connectors, controls, electrical, hydraulic components, etc. may be provided as known in the relevant art.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is to be determined not by the illustrative examples set forth above, but by the appended claims and their legal equivalents.

I claim:

1. A release mechanism for selectively holding and releasing a member in a tether assembly, thereby parting the tether assembly, comprising a locking mechanism comprising:
a circular base ring having a central opening sized to accommodate an elongated connecting member, said circular base ring further comprising a plurality of radial channels therein;
a circular cam ring rotatably connected to said base ring, said cam ring comprising a central opening sized to accommodate an elongated connecting member and further comprising a plurality of angled slots therein;
a plurality of elongated dogs disposed in said radial channels in said circular base ring, each of said dogs comprising a raised portion proximal a radially outward end thereof which engages one of said angled slots in said circular cam ring,
wherein said angled slots in said cam ring are shaped so as to force said dogs radially inwardly and outwardly with relative rotation between said circular base ring and said circular cam ring.

2. The apparatus of claim 1, further comprising a means for creating said relative rotation between said circular base ring and said circular cam ring.

3. The apparatus of claim 2, wherein said means for creating said relative rotation between said circular base ring and said circular cam ring comprises one or more hydraulic cylinders connected to said circular base ring and said circular cam ring, and a pressurized hydraulic fluid source operatively connected to said one or more hydraulic cylinders.

4. The apparatus of claim 3, further comprising an elongated connecting member sized to fit within said circular opening, said connecting member comprising a circumferential groove on an outside surface, and wherein said dogs engage said circumferential groove when said dogs are in a radially inward position, thereby connecting said tether assembly; and wherein said dogs in a radially outward position do not engage said circumferential groove, thereby disconnecting said tether assembly.

5. The apparatus of claim 3, further comprising a cap ring positioned over said dogs and connected to said base ring.

6. The apparatus of claim 3, further comprising one or more hydraulic accumulators operably attached to said locking mechanism and fluidly connected to said hydraulic cylinders.

7. The apparatus of claim 6, further comprising springs which bias said circular cam ring toward a position wherein said dogs are in a radially inward position.

8. The apparatus of claim 7, further comprising controls which control hydraulic fluid flow to said hydraulic accumulators and to said hydraulic cylinders.

9. The apparatus of claim 8, wherein said springs are coil springs disposed around said hydraulic cylinders.

10. The apparatus of claim 9, wherein said hydraulic accumulators comprise high pressure hydraulic accumulators and low pressure hydraulic accumulators.

11. The apparatus of claim 1, wherein said angled slots are shaped so that when said cam ring is rotated to a position in which said dogs are forced to their radially inward position, said dogs are locked in said radially inward position.

12. An apparatus for releasably connecting to a tether, comprising:
a circular base ring having a central opening sized to accommodate an elongated connecting member therein, said circular base ring further comprising a plurality of radial channels therein;
a circular cam ring rotatably connected to said base ring, said cam ring comprising a central opening sized to accommodate said elongated connecting member and further comprising a plurality of angled slots therein;
a plurality of elongated dogs disposed in said radial slots in said circular base ring, each of said dogs comprising a raised portion proximal a radially outward end thereof which engages one of said angled slots in said circular cam ring,
wherein said angled slots in said cam ring are shaped so as to force said dogs radially inwardly and outwardly with relative rotation between said circular base ring and said circular cam ring; and
one or more hydraulic cylinders connected to said circular base ring and said circular cam ring, and a pressurized hydraulic fluid source connected to said hydraulic cylinders, wherein extension and retraction of said hydraulic cylinders causes relative rotation between said base ring and said cam ring.

13. The apparatus of claim 12, further comprising one or more hydraulic accumulators operably attached to said locking mechanism and fluidly connected to said hydraulic cylinders.

14. The apparatus of claim 13, further comprising springs disposed between said base ring and said cam ring and biasing said cam ring toward a position wherein said dogs are positioned radially inward.

15. The apparatus of claim 14, wherein said springs comprise coil springs disposed around said hydraulic cylinders.

16. The apparatus of claim 14, wherein said hydraulic accumulators comprise high pressure accumulators and low pressure accumulators.

17. The apparatus of claim 12, wherein said angled slots are shaped so that when said cam ring is rotated to move said dogs to their radially inward position, said dogs are locked in said radially inward position.

18. The apparatus of claim 17, further comprising an elongated connecting member sized to fit within said circular opening, said connecting member comprising a circumferential groove on an outside surface, and wherein said dogs engage said circumferential groove when said dogs are in a radially inward position, thereby connecting said tether assembly; and wherein said dogs in a radially outward position do not engage said circumferential groove, thereby disconnecting said tether assembly.
